(19) United States
(12) Patent Application Publication
(10) Pub. No.: US 2015/0214732 A1
(43) Pub. Date: Jul. 30, 2015

(54) SEMICONDUCTOR CIRCUIT

(71) Applicant: KABUSHIKI KAISHA TOSHIBA, Tokyo (JP)

(72) Inventors: Satoshi HARUKI, Yokosuka Kanagawa (JP); Kazuhiro KATO, Yokohama Kanagawa (JP)

(21) Appl. No.: 14/678,311

(22) Filed: Apr. 3, 2015

Related U.S. Application Data
(63) Continuation-in-part of application No. 14/191,268, filed on Feb. 26, 2014.

(30) Foreign Application Priority Data
May 13, 2013 (JP) 2013-101173
Apr. 4, 2014 (JP) 2014-078191

(51) Int. Cl. H02H 9/04

(52) U.S. Cl. CPC H02H 9/046

(57) ABSTRACT

A semiconductor circuit includes a clamp circuit and a switch circuit connected in series between a first power source terminal and a second power source terminal. The clamp circuit is configured to connect the first power source terminal to the second power source terminal when a voltage difference between the first and second power source terminals exceeds a threshold value. A control circuit controls the switch circuit such that the switch circuit is not conductive (open) when the voltage difference between the power source terminals is constant and is conductive (closed) when the voltage difference between the first and second power source terminals changes by more than a predetermined magnitude.

### CROSS-REFERENCE TO RELATED APPLICATIONS

This is a continuation-in-part application of application Ser. No. 14/191,268 filed on Feb. 26, 2014, which claims the benefit of priority from Japanese Patent Application No. 2013-101173 filed on May 13, 2013. This application also claims the benefit of priority from Japanese Patent Application No. 2014-78191 filed on Apr. 4, 2014 which claims the internal priority from Japanese Patent Application No. 2013-101173. The entire contents of these applications are incorporated herein by reference.

### FIELD

Embodiments described herein relate generally to a semiconductor circuit which protects an internal circuit connected between power source lines from ESD surge.

### BACKGROUND

Various types of protection circuits providing protection from ESD (electrostatic discharge) have been proposed. ESD includes discharge from a human or machine charged by static electricity to a semiconductor device, discharge from a charged semiconductor device to the ground potential, and other types of discharge. When ESD occurs to a semiconductor device, a large current flow is produced from a corresponding terminal toward the semiconductor device. The surge of current generates a high voltage within the semiconductor device which may cause a dielectric breakdown of internal elements or other failure of the semiconductor device.

A protection element called RCT (RC triggered) MOS transistor includes a MOS transistor for voltage clamping the semiconductor device to a maximum voltage level is driven by an RC circuit as a triggering circuit.

According to the RCT MOS transistor, however, the RC circuit also responds to the surge of the power source voltage generated during the operation of an internal circuit connected between power source lines, and may turn on the MOS transistor even without the presence of ESD. In this case, problems may be caused such as generation of a so-called rush current which inhibits the intended rise of the power source voltage, and also an increase in the current consumption during device operation when the MOS transistor for clamping is inadvertently or mistakenly operated.

### BRIEF DESCRIPTION OF THE DRAWINGS

FIG. 1 is a block diagram of a first embodiment.

FIG. 2 illustrates an exemplary structure of the first embodiment.

FIG. 3 is a block diagram of a second embodiment.

FIG. 4 illustrates an exemplary structure of the second embodiment.

FIG. 5 is a block diagram of a third embodiment.

FIG. 6 is a block diagram of a fourth embodiment.

FIG. 7 illustrates an exemplary structure of the fourth embodiment.

FIG. 8 is a block diagram of a fifth embodiment.

FIG. 9 is a block diagram of a sixth embodiment.

### DETAILED DESCRIPTION

In general, according to one embodiment, it is an object to provide a semiconductor circuit capable of preventing malfunction of a clamp circuit for ESD protection.

In an embodiment, a semiconductor circuit comprises a clamp circuit and a switch circuit connected in series between a first power source terminal and a second power source terminal. The clamp circuit is configured to connect the first power source terminal to the second power source terminal when a voltage difference between the first and second power source terminals exceeds a predetermined threshold value. For example, when an ESD causes a voltage surge, the clamp circuit acts to dissipate the surge. A control circuit is configured to control a conductance state of the switch circuit between an ON and an OFF conductance state. In the ON conductance state the main current path of the switch circuit is conductive and in the OFF conductance state the main current path of the switch circuit is non-conductive. The control circuit controls the switch circuit such that the switch circuit is in the OFF conductance state when the voltage difference between the first and second power source terminals is constant (not changing) and the switch circuit is in an ON conductance state when a change in the voltage difference between the first and second power source terminals exceeds a predetermined magnitude.

According to one embodiment, a semiconductor circuit includes a first power source terminal to which a first power source voltage is applied, a first power source line connected with the first power source terminal, a second power source terminal to which a second power source voltage is applied, and a second power source line connected with the second power source terminal. The semiconductor circuit includes an internal circuit connected between the first power source line and the second power source line. The semiconductor circuit includes a clamp circuit connected in series between the first power source line and the second power source line via at least one switch unit. The semiconductor circuit includes a control circuit supplying to the switch unit a control signal for controlling on-off of the switch unit.

A semiconductor circuit according to exemplary embodiments is hereinafter described in detail in conjunction with the accompanying drawings. These embodiments are presented by way of example only, and do not impose any limitations on the intended scope of this

### First Embodiment

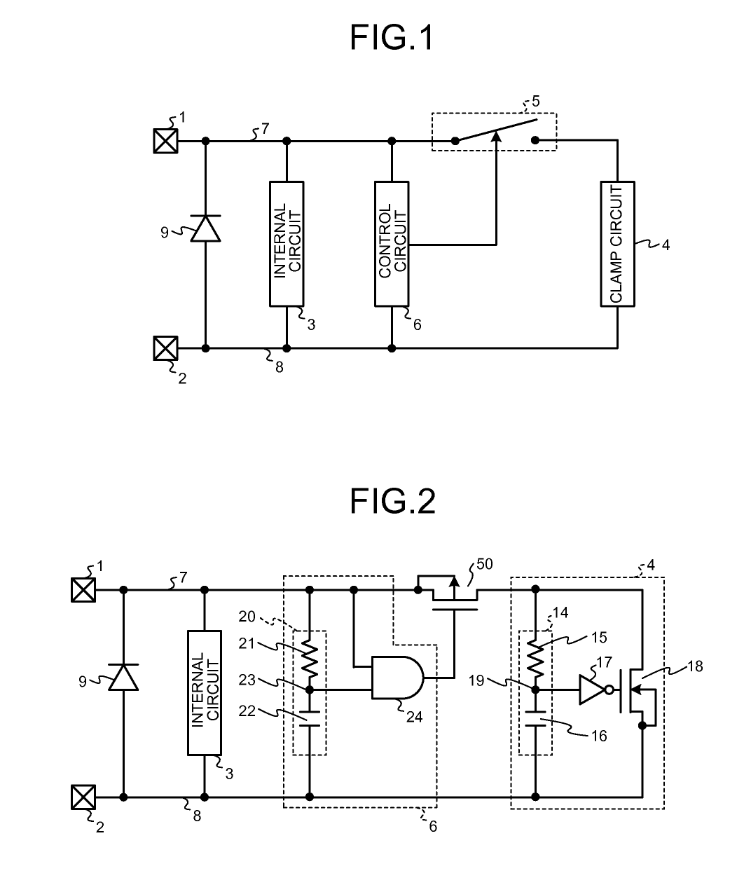

FIG. 1 is a block diagram of a semiconductor circuit according to a first embodiment. The semiconductor circuit in this embodiment includes a first power source terminal 1 to which a high potential side power source voltage is applied as a first power source voltage. In a steady-state condition, a voltage of 5V, for example, may be applied to the first power source terminal 1. The ground potential, for example, as a low potential side voltage is applied to a second power source terminal 2. A high potential side first power source line 7 is connected to the first power source terminal 1. A low potential side second power source line 8 is connected to the second power source terminal 2.

An internal circuit 3 is connected between the first power source line 7 and the second power source line 8 and is biased by a voltage between the first power source line 7 and the second power source line 8 and performs predetermined circuit operation.

A clamp circuit 4 is a circuit for protecting the internal circuit 3 from an ESD surge. The clamp circuit 4 is connected in series with a switch unit 5 between the first power source line 7 and the second power source line 8.

The on-off state of the switch unit 5 is controlled in accordance with a control signal generated from a control circuit 6 connected between the first power source line 7 and the second power source line 8.

The cathode electrode of an ESD protection diode 9 is connected to the first power source line 7, while the anode electrode of the ESD protection diode 9 is connected to the second power source line 8. When the ESD surge is applied to the power source terminal 2, the ESD protection diode 9 is conductive and discharges the ESD surge. The ESD protection diode 9 is optional in this embodiment and may be eliminated.

In the steady condition, the control circuit 6 outputs the control signal for turning off the switch unit 5. More specifically, when a predetermined voltage for allowing operation of the internal circuit 3, such as 5V, is applied between the first power source terminal 1 and the second power source terminal 2, the switch unit 5 is turned off. When the switch unit 5 is in an off state (non-conductance state), the first power source line 7 and the clamp circuit 4 are disconnected from each other. This prevents transmission of a voltage surge generated between the first power source line 7 and the second power source line 8 to the clamp circuit 4, that is, this disconnection can prevent malfunction of the clamp circuit 4 caused by the voltage surge. Accordingly, this structure prevents problems such as the inhibition of an intended rise in the power source voltage, and an increase in the current consumption caused by unintended or unnecessary operation of the clamp circuit 4.

FIG. 2 illustrates an example of a specific structure of the first embodiment. The elements in FIG. 2 corresponding to the elements in FIG. 1 are given the same reference numbers, and the associated explanation may not be repeated.

One end of the clamp circuit 4 is connected to one end of a p-channel metal-oxide-semiconductor (PMOS) transistor 50, which forms the switch unit 5. The other end of the PMOS transistor 50 is connected to the first power source line 7. Thus, the one end of the clamp circuit 4 is connected to the first power source line 7 via a source-drain channel of the PMOS transistor 50. The source drain-channel corresponds to a main current channel of the PMOS transistor 50. The other end of the clamp circuit 4 is connected to the second power source line 8.

According to this structure, the clamp circuit 4 is connected in series with the PMOS transistor 50 between the first power source line 7 and the second power source line 8. The clamp circuit 4 includes a first RC circuit 14 constituted by a series circuit of a first resistor 15 and a first capacitor 16. That is, first resistor 15 and first capacitor 16 are connected in series with each other. The clamp circuit 4 further includes an inverter 17 having input connection (e.g., terminal or electrode) connected to a first common node 19 (output end of the first RC circuit 14) to which the first resistor 15 and the first capacitor 16 are connected.

The clamp circuit 4 further includes an NMOS transistor for clamping (hereinafter referred to as NMOS clamp transistor) 18. The source-drain channel of the NMOS clamp transistor 18 is connected in parallel with the first RC circuit 14 between first power source line 7 and second power source line 8. The output of the inverter 17 is applied to the gate electrode of the NMOS clamp transistor 18.

According to this embodiment, therefore, the conductance state of NMOS clamp transistor 18 is controlled by the first RC circuit 14. In this embodiment, the inverter 17 is provided between the first RC circuit 14 and the gate electrode of the NMOS clamp transistor 18. The specific structure of inverter 17 is not limited to the structure depicted in FIG. 2. A circuit or connection between RC circuit 14 and the gate electrode of the NMOS clamp transistor 18 is not limited to an inverter 17 but may be any circuit of any type as long as a correct logic is output to control NMOS claim transistor 18. Similar modifications to the corresponding structure of a second embodiment, described below, may also be made.

The control circuit 6 includes a second RC circuit 20 formed by a second resistor 21 and a second capacitor 22 connected in series between the first power source line 7 and the second power source line 8. The control circuit 6 further includes an AND circuit 24 having two input ends (e.g., terminals). A first input end of the AND circuit 24 is connected to a second common node 23 (output end of the second RC circuit 20) to which the second resistor 21 and the second capacitor 22 are connected. A second input end of the AND circuit 24 is connected to the first power source line 7. An output end (e.g., terminal) of the AND circuit 24 is connected to the gate (control) electrode of the PMOS transistor 50.

The potential of the power source lines corresponds to the potential applied to the respective power source terminals. That is, when a 5V potential is applied to the first power source terminal 1 and the ground potential is applied to the second power source terminal 2, the potential of the first power source line 7 becomes 5V. The potential at the second common node 23 of the second RC circuit 20 of the control circuit 6 also becomes 5V. In this case, a HIGH level voltage (signal) is input to both the first and second input ends of the AND circuit 24, wherefore the AND circuit 24 supplies a HIGH level output signal to the gate electrode of the PMOS transistor 50. As a result, the PMOS transistor 50 is turned off, creating high impedance between the first power source line 7 and the clamp circuit 4. This condition can prevent transmission of voltage surge generated between the first power source line 7 and the second power source line 8 to the clamp circuit 4, that is, can avoid malfunction of the clamp circuit 4 caused in response to an increase in the power source voltage. Accordingly, this structure is effective in preventing problems such as a condition inhibiting rise of the power source voltage, and increase in the current consumption produced as a result of malfunction of the clamp circuit 4.

On the other hand, when ESD surge is applied to the first power source terminal 1 while no power source voltage is applied between the first power source terminal 1 and the second power source terminal 2, the first RC circuit 20 responds to the ESD surge and allows transient flow of current between the first power source terminal 1 and the second power source terminal 2. This current flow generates a voltage drop across the second resistor 21 of the second RC circuit 20. In response to the voltage drop across the second resistor 21, a LOW level signal is input to the first input end of the AND circuit 24. On the other hand, HIGH level is inputted to the second input end of the AND circuit 24, wherefore the output of the AND circuit 24 becomes LOW level.

When a LOW level control signal is applied to the gate electrode of the PMOS transistor 50, the PMOS transistor 50 is turned on (on conductance state). When the PMOS transistor 50 is in the on conductance state, the clamp circuit 4 is connected to the first power source line 7 with low impedance. As a result, the first RC circuit 14 of the clamp circuit 4 responds to the voltage between the first power source line 7 and the second power source line 8, whereby current transiently flows between the first power source line 7 and the second power source line 8 via the first RC circuit 14. This current generates a voltage drop across the first resistor 15 of the first RC circuit 14.

When the potential at the first common node 19 becomes a value equal to or lower than the threshold of the inverter 17 by the voltage drop thus generated, a HIGH level output signal is supplied from the inverter 17 to the gate electrode of the NMOS clamp transistor 18. The supply of the HIGH level signal to the gate electrode of the NMOS clamp transistor 18 turns on the NMOS clamp transistor 18 and allows discharge of ESD surge through the NMOS clamp transistor 18.

When an ESD surge is applied to the second power source terminal 2, the ESD protection diode 9 is turned on and allows discharge of ESD surge.

### Second Embodiment

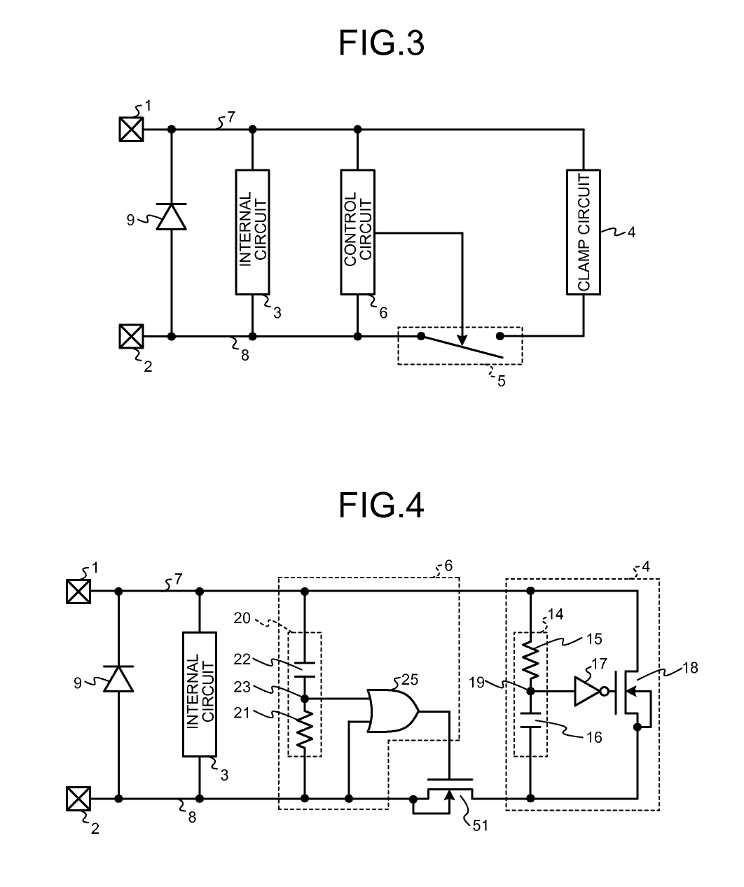

FIG. 3 is a block diagram of a second embodiment. The elements similar to the elements of already described embodiments are given the same reference numbers, and the explanation of these elements may not be repeated.

According to this second embodiment, the switch unit 5 is disposed on the second power source line 8 side corresponding to the low potential side. In the steady-state operating condition, the control circuit 6 supplies a control signal for turning off the switch unit 5. More specifically, in the steady-state condition, constant voltages are supplied for allowing operation of the internal circuit 3 connected between the first power source terminal 1 and the second power source terminal 2. For example a 5V potential may be applied to the first power source terminal 1 and the ground potential to the second power source terminal 2. In this steady-state condition, the switch unit 5 is turned off. When the switch unit 5 is in an off conductance state, the clamp circuit 4 and the second power source line 8 are disconnected from each other. This condition can prevent transmission of a voltage surge generated between the first power source line 7 and the second power source line 8 to the clamp circuit 4, that is, can avoid malfunction of the clamp circuit 4 caused by a surge of the power source voltage. Accordingly, this structure is effective in preventing problems such as an inhibition in an intended rise of the power source voltage, and an increase in current consumption when the clamp circuit 4 is erroneously operated.

FIG. 4 illustrates an example of a specific structure of the second embodiment. The elements corresponding to the elements in the already described embodiments are given the same reference numbers, and explanation of repeated elements may not be repeated.

The control circuit 6 includes the second RC circuit 20 connected between the first power source line 7 and the second power source line 8. The second RC circuit 20 is formed the second capacitor 22 and the second resistor 21 connected in series.

The control circuit 6 further includes an OR circuit 25 having two input ends (e.g., terminals). A first input end of the OR circuit 25 is connected to the second common node 23 (output end of the second RC circuit 20) to which the second resistor 21 and the second capacitor 22 of the second RC circuit 20 are connected. A second input end of the OR circuit 25 is connected with the second power source line 8. The source electrode of an NMOS transistor 51 forming the switch unit 5 is connected to the second power source line 8. An output end (terminal) of the OR circuit 25 is supplied to the gate (control) electrode of the NMOS transistor 51

One end of the clamp circuit 4 is connected to the drain electrode of the NMOS transistor 51. According to this structure, the source-drain channel of the NMOS transistor 51 is connected between the second power source line 8 and the clamp circuit 4. The other end of the clamp circuit 4 is connected to the first power source line 7. Thus, the clamp circuit 4 is connected in series with the NMOS transistor 51 between the first power source line 7 and the second power source line 8.

In the steady-state condition, i.e., when predetermined power source voltages are applied, such as 5V for the first power source terminal 1 and the ground potential for the second power source terminal 2, the potential of the second power source line 8 becomes 0V. Similarly, the potential at the second common node 23 of the second RC circuit 20 of the control circuit 6 becomes the ground voltage, i.e., 0V. In this case, a LOW level signal (voltage) is inputted to each of the first and second input ends of the OR circuit 25, wherefore the OR circuit 25 supplies a LOW level signal to the gate electrode of the NMOS transistor 51. As a result, the NMOS transistor 51 is turned off, creating high impedance between the second power source line 8 and the clamp circuit 4. This prevents the transmission of a voltage surge generated between the first power source line 7 and the second power source line 8 to the clamp circuit 4. Accordingly, this structure is effective in preventing problems such inhibition of an intended rise of the power source voltage, and an increase in the current consumption when the clamp circuit 4 is erroneously operated.

On the other hand, when ESD surge positive for the second power source terminal 2 is applied to the first power source terminal 1, the second RC circuit 20 of the control circuit 6 responds to the ESD surge and allows current to flow transiently between the first power source terminal 1 and the second power source terminal 2. This current flow generates a voltage drop across the second resistor 21 of the second RC circuit 20.

In response to the voltage drop across the second resistor 21, a HIGH level signal (voltage) is input to the first input end of the OR circuit 25. A LOW level signal (voltage) is input to the second input end of the OR circuit 25; wherefore the output of the OR circuit 25 becomes HIGH level.

When a HIGH level control signal is applied to the gate electrode of the NMOS transistor 51, the NMOS transistor 51 is turned on (i.e., the source-drain path is placed in an on conductance state). In response to the on condition of the NMOS transistor 51, the clamp circuit 4 is connected to the second power source line 8 with low impedance. As a result, the first RC circuit 14 of the clamp circuit 4 responds to the voltage difference between the first power source line 7 and the second power source line 8, whereby current transiently flows between the first power source line 7 and the second power source line 8 via the first RC circuit 14. This current generates a voltage drop across the first resistor 15 of the first RC circuit 14.

When the potential at the first common node 19 becomes a value equal to or lower than the threshold of the inverter 17 by the voltage drop thus generated across the first resistor 15 of the first RC circuit 14, a HIGH level output signal is supplied from the inverter 17 to the gate electrode of the NMOS clamp transistor 18.

The supply of the HIGH level signal to the gate electrode of the NMOS clamp transistor 18 turns on the NMOS clamp transistor 18 and allows discharge of ESD surge current. When ESD surge is applied to the second power source terminal 2, the ESD protection diode 9 is turned on and allows discharge of ESD surge.

While examples which include MOS (metal-oxide-semiconductor) transistors functioning as switch transistors is discussed in the respective embodiments, a structure which contains bi-polar transistors can be employed. In the case of the structure containing bi-polar transistors, the main current channel corresponds to the emitter-collector channel, while the control electrode corresponds to the base electrode. In this case, NPN transistors may be used in place of the NMOS transistors in view of the bias condition.

Moreover, such structure may be employed that includes switch units in both the power source line on the high potential side and in the power source line on the low potential side, such as in a combination of the first and second embodiments within one device.

### Third Embodiment

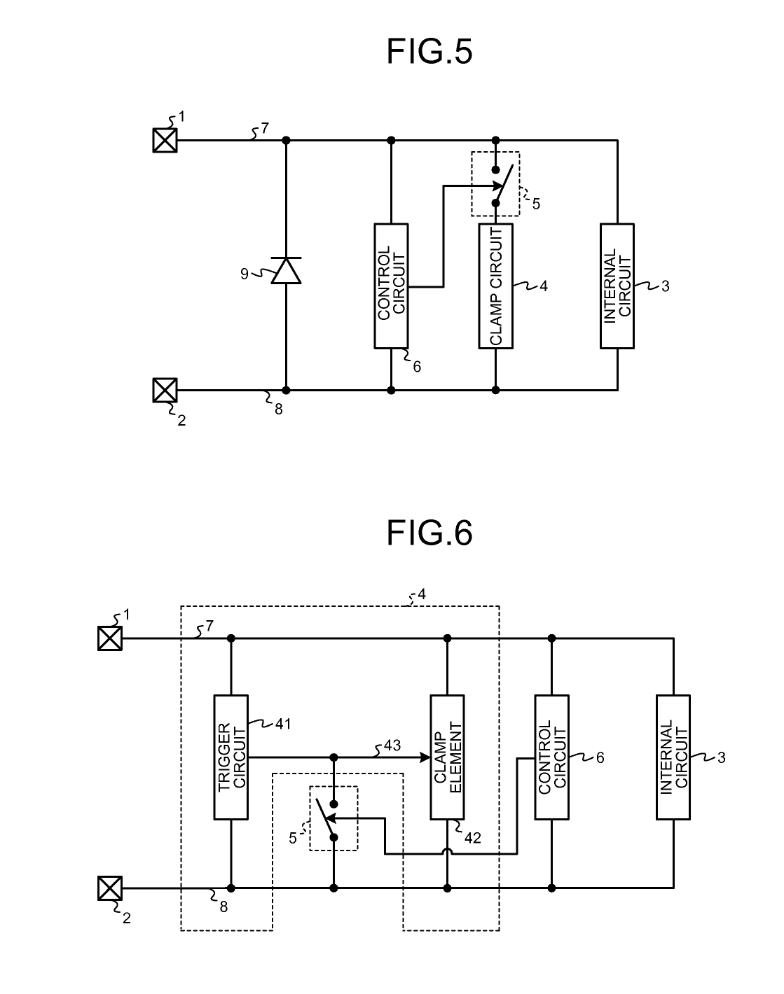

FIG. 5 is a block diagram of a third embodiment. The elements corresponding to the elements in the already described embodiments are given the same reference numbers, and the explanation of these elements may not be repeated. According to this embodiment, the internal circuit 3 is connected to the first power source terminal 1 and the second power source terminal 2 through the first power source line 7 and the second power source line 8. The control circuit 6 is connected between the first power source line 7 and the second power source line 8. The series circuit formed of the clamp circuit 4 and the switch unit 5 is connected between the first power source line 7 and the second power source line 8. The switch unit 5 is controlled on-off by a control signal from the control circuit 6.

According to this embodiment, when the ESD surge positive for the second power source terminal 2 is applied to the first power source terminal 1, the switch unit 5 is turned on by the control signal from the control circuit 6, causing the clamp circuit 4 to operate and allowing the ESD surge to be discharged. When the ESD surge positive for the first power source terminal 1 is applied to the second power source terminal 2, the ESD protection diode 9 is turned on and allows the ESD surge to be discharged. The internal circuit 3 is protected from the ESD surge as a result.

In the steady-state condition where, for example, the voltage equal to 5 V is applied to the first power source terminal 1 while the ground potential is applied to the second power source terminal 2, the switch unit 5 is turned off by the control signal from the control circuit 6 so that the transmission of a voltage fluctuation such as the voltage surge generated between the first power source line 7 and the second power source line 8 to the clamp circuit 4 can be prevented. This can therefore prevent the problems such as the inhibition of the intended rise of the power source voltage and the increase in the current consumption caused by the malfunction of the clamp circuit 4. Once the switch unit 5 is turned off, the clamp circuit 4 is disconnected from the first power source line 7 and unable to perform a clamp operation.

While the embodiment using the MOS transistor as a switching transistor has been described, a structure employing a bi-polar transistor can be adopted as well. When the bi-polar transistor is used, the main current path corresponds to the emitter-collector path while the control electrode corresponds to the base electrode. In this case, NPN transistors may be used in place of the NMOS transistors in view of the bias condition. Moreover, such structure may be employed that includes switch units in both the power source line on the high potential side and the power source line on the low potential side.

### Fourth Embodiment

FIG. 6 is a block diagram of a fourth embodiment. The elements corresponding to the elements in the already described embodiments are given the same reference numbers, and the explanation of these elements may not be repeated. In this embodiment, the clamp circuit 4 is connected between the first power source line 7 and the second power source line 8. The clamp circuit 4 includes a trigger circuit 41 and a clamp element 42 that are connected between the first power source line 7 and the second power source line 8. The clamp element 42 is formed of a MOS transistor, for example. The clamp element 42 is controlled on-off by a trigger signal from the trigger circuit 41.

The switch unit 5 is connected between a signal line 43 and the second power source line 8, the signal line supplying the trigger signal from the trigger circuit 41 to the clamp element 42. The switch unit 5 is controlled on-off by the control signal from the control circuit 6. That is, when the switch unit 5 is turned on by the control signal from the control circuit 6, the ground potential being the potential of the second power source line 8 is supplied to the clamp element 42 through the signal line 43 to cut off the conduction of the clamp element 42. The clamp element 42 is unable to perform the clamp operation as a result.

The control circuit 6 outputs the control signal when the voltage between the first power source line 7 and the second power source line 8 exceeds a predetermined threshold voltage, and supplies the signal to the switch unit 5. The threshold voltage of the control circuit 6 is set in consideration of a power source voltage applied to the first power source terminal 1 and a ground voltage applied to the second power source terminal 2 in the steady-state condition as well as the voltage fluctuation such as the voltage surge anticipated by a normal operation of the internal circuit 3, for example. This is to avoid the clamp circuit 4 performing the clamp operation upon responding to the voltage fluctuation between the power source lines generated by the normal operation of the internal circuit 3.

In the steady-state condition where a power source voltage VDD is applied between the first power source terminal 1 and the second power source terminal 2, the threshold voltage of the control circuit 6 is set to VDD+(VV)/2, for example, when the power source voltage is anticipated to fluctuate to (VDD+VV) by the normal operation of the internal circuit 3. In other words, the threshold voltage of the control circuit 6 is set to a voltage higher than the power source voltage VDD by one-half of the amount of fluctuation (VV) of the power source voltage. When a variation of approximately ±10% is permitted to the power source voltage VDD applied between the first power source terminal 1 and the second power source terminal 2, the threshold voltage of the control circuit 6 is set in consideration of the permitted variation.

In this embodiment, the clamp circuit 4 is controlled by the control signal from the control circuit 6 to be in the state unable to perform the clamp operation, when the voltage applied between the first power source terminal 1 and the second power source terminal 2 exceeds the predetermined threshold voltage of the control circuit 6 set in consideration of the voltage fluctuation caused by the normal operation of the internal circuit 3, for example. In other words, the clamp operation of the clamp circuit 4 is controlled by monitoring the voltage applied between the first power source terminal 1 and the second power source terminal 2. This can avoid the situation where the clamp circuit 4 malfunctions by responding to the voltage fluctuation between the power source terminals caused by the normal operation of the internal circuit 3. Note that the normal operation of the internal circuit 3 may cause the power source voltage to fluctuate between the power source voltage VDD applied between the first power source terminal 1 and the second power source terminal 2 and the threshold voltage of the control circuit 6 such as VDD+(VV)/2, and cause the trigger circuit 41 of the clamp circuit 4 to respond to the fluctuation of the power source voltage to turn on the clamp element 42. It is however less likely that the clamp element 42 of the clamp circuit 4 stays on over a long period of time because the clamp element 42 is turned off by the control signal from the control circuit 6 when the power source voltage exceeds the threshold voltage of the control circuit 6 even once.

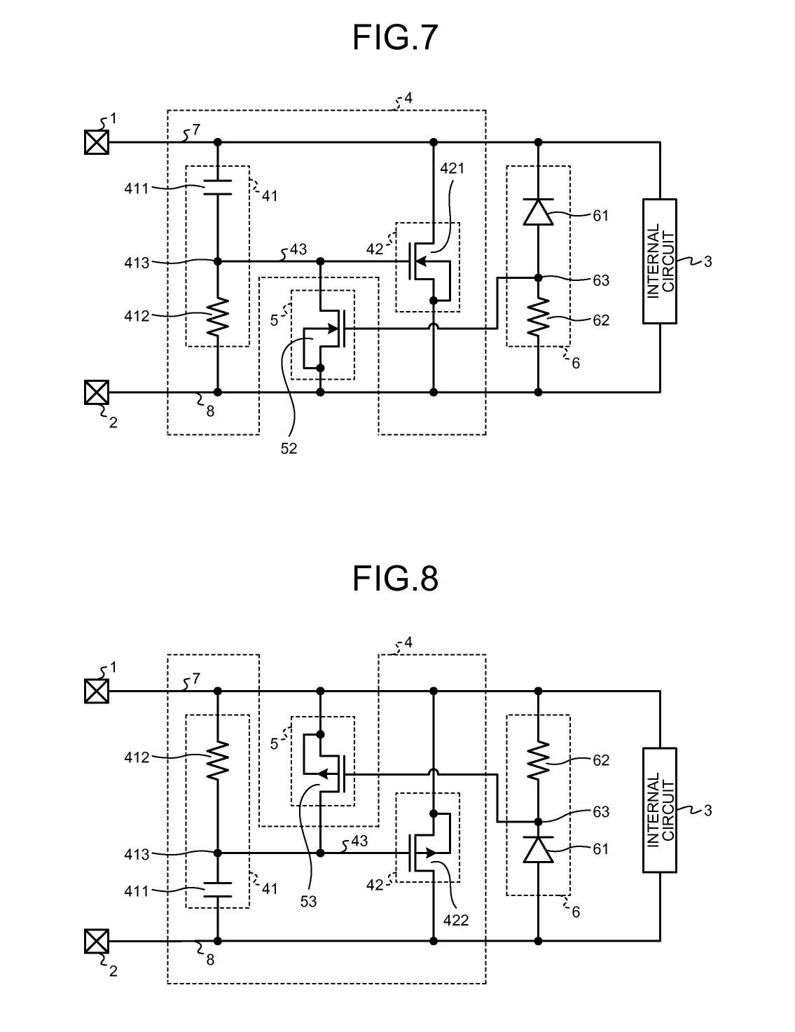

FIG. 7 illustrates an example of a specific structure of the fourth embodiment. The elements corresponding to the elements in the already described embodiments are given the same reference numbers, and the explanation of these elements may not be repeated. The trigger circuit 41 of the clamp circuit 4 includes a series circuit formed of a capacitor 411 and a resistor 412. The capacitor 411 and the resistor 412 are connected by a third common node 413. The clamp element 42 includes an NMOS clamp transistor 421. The third common node 413 is connected to a gate electrode of the NMOS clamp transistor 421 through the signal line 43.

The switch unit 5 includes an NMOS transistor 52. A source electrode of the NMOS transistor 52 is connected to the second power source line 8 while a drain electrode of the transistor is connected to the signal line 43.

The control circuit 6 includes a series circuit formed of a diode 61 and a resistor 62. The diode 61 and the resistor 62 are connected by a fourth common node 63. The fourth common node 63 is connected to a gate electrode of the NMOS transistor 52. The diode 61 is reverse-biased by a voltage applied between the first power source terminal 1 and the second power source terminal 2 in the steady-state condition. A breakdown voltage of the diode 61 is set in consideration of a fluctuation of a voltage applied between the first power source terminal 1 and the second power source terminal 2 in the steady-state condition and a voltage applied between the power source terminals generated by the operation of the internal circuit 3 in the steady-state condition. This is to avoid the situation where the clamp circuit 4 malfunctions upon responding to the fluctuation of the power source voltage generated by the normal operation of the internal circuit 3 in the steady-state condition.

The following is the operation of a surge test assuming a case where the ESD surge positive for the second power source terminal 2 is applied to the first power source terminal 1 when no voltage is applied between the first power source terminal 1 and the second power source terminal 2. In the ESD surge test, for example, a time constant of a CR circuit formed of the resistor 412 and the capacitor 411 included in the trigger circuit 41 is set to a value satisfying an ESD test standard. An ESD human body model (HBM method: Human Body Model) performs a test of discharging an electric charge charged to 100 pF (picofarads) through a 1.5 kΩ (kiloohm) resistor. Therefore, a time constant of the trigger circuit 41 is set to 1 μS (microsecond) that is a value six to seven times as large as 150 nS (nanoseconds), for example, by considering a time constant set to 150 nS by a 100 pF capacitor and the 1.5 kΩ resistor conforming to the ESD test standard. This is to fully discharge the ESD surge. The time constant can be set to 1 μS by setting the value of the resistor 412 to 1 MΩ (megaohm) and the value of the capacitor 411 to 1 pF, for example.

The trigger circuit 41 responds to the ESD surge applied between the first power source terminal 1 and the second power source terminal 2, whereby current flows transiently. This transient current causes the potential of the third common node 413 set by a voltage drop voltage generated in the resistor 412 to be supplied as a trigger signal to a gate electrode of the NMOS clamp transistor 421 forming the clamp element 42. The NMOS clamp transistor 421 is turned on when the voltage drop voltage in the resistor 412 exceeds a threshold set to the NMOS clamp transistor 421. The ESD surge is discharged when the NMOS clamp transistor 421 is turned on. When the NMOS clamp transistor 421 is turned on to cause the clamp operation to be performed, the voltage applied between the first power source line 7 and the second power source line 8 is clamped to a source-drain voltage of the NMOS clamp transistor 421. The voltage generated by the ESD surge test between the first power source line 7 and the second power source line 8 does not exceed the threshold voltage of the control circuit 6, whereby the diode 61 is not turned on. Accordingly, the control signal is not supplied from the control circuit 6 to the gate electrode of the NMOS transistor 52, which is thus in an off state.

When there is no fluctuation in the voltage between the first power source line 7 and the second power source line 8 in the steady-state condition, namely a condition where a predetermined voltage such as 5 V is applied to the first power source terminal 1 while the ground potential is applied to the second power source terminal 2, the trigger signal from the trigger circuit 41 and the control signal from the control circuit 6 are not output. The NMOS clamp transistor 421 and the NMOS transistor 52 are thus in an off state.

There is performed an operation as follows when a fluctuation in the voltage exceeding the threshold voltage of the control circuit 6 is generated between the first power source line 7 and the second power source line 8 in the steady-state condition, namely a condition where the predetermined voltage such as 5 V is applied to the first power source terminal 1 while the ground potential is applied to the second power source terminal 2. The trigger circuit 41 responds to the fluctuation in the voltage between the power source terminals, whereby the trigger signal is supplied to the gate electrode of the NMOS clamp transistor 421. On the other hand, the control circuit 6 supplies the control signal to the gate electrode of the NMOS transistor 52. The NMOS transistor 52 is thus turned on so that the ground potential of the second power source line 8 is supplied to the gate electrode of the NMOS clamp transistor 421. As a result, the NMOS clamp transistor 421 is turned off, causing a state where the clamp operation cannot be performed.

In this embodiment, a signal that forcibly turns off the NMOS clamp transistor 421 is supplied to the gate electrode of the NMOS clamp transistor 421 through the switch unit 5 when the voltage between the first power source line 7 and the second power source line 8 exceeds the threshold voltage of the control circuit 6. The clamp circuit 4 thus cannot perform the clamp operation. That is, a range of voltage between the power source terminals in which the clamp circuit 4 performs the clamp operation can be set arbitrarily by arbitrarily setting the threshold voltage at which the control circuit 6 outputs the control signal. This can thus avoid the malfunction of the clamp circuit 4 caused by the fluctuation in the power source voltage generated by the normal operation of the internal circuit 3. The diode 61 included in the control circuit 6 may also be configured where a plurality of diodes is connected in series. The threshold voltage of the control circuit 6 can be adjusted by the adjustment of the number of stages of the diode.

### Fifth Embodiment

FIG. 8 is a diagram illustrating a fifth embodiment. The elements corresponding to the elements in the already described embodiments are given the same reference numbers, and the explanation of these elements may not be repeated. In this embodiment, a PMOS clamp transistor 422 is included as the clamp element 42 of the clamp circuit 4. The connection position of the capacitor 411 and the resistor 412 included in the trigger circuit 41 and the connection position of the already described embodiment illustrated in FIG. 7 are exchanged.

Likewise, the connection position of the diode 61 and the resistor 62 included in the control circuit 6 and the connection position of the already described embodiment illustrated in FIG. 7 are exchanged. The switch unit 5 includes a PMOS transistor 53 forming a switching transistor.

In the ESD surge test of this embodiment, when the ESD surge positive for the second power source terminal 2 is applied to the first power source terminal 1, the PMOS clamp transistor 422 is turned on to allow the ESD surge to be discharged once a voltage drop voltage generated in the resistor 412 exceeds a threshold of the PMOS transistor 422. The voltage generated between the first power source line 7 and the second power source line 8 by the ESD surge test does not exceed the threshold voltage of the control circuit 6, whereby the diode 61 is not turned on. Accordingly, the control signal is not supplied from the control circuit 6 to the gate electrode of the PMOS transistor 53, which is thus in an off state. The voltage between the first power source line 7 and the second power source line 8 is clamped to a source-drain voltage of the PMOS clamp transistor 422 when the clamp operation is performed by turning on the PMOS clamp transistor 422.

When the voltage between the first power source line 7 and the second power source line 8 exceeds the threshold voltage of the control circuit 6 in the steady-state condition where a predetermined power source voltage is applied to the first power source terminal 1 and the second power source terminal 2, the control circuit 6 is conductive and allows current to flow transiently. The PMOS transistor 53 is turned on when the voltage drop voltage of the resistor 62 generated by the transient current exceeds the threshold of the PMOS transistor 53, whereby the voltage of the first power source line 7 is applied to the signal line 43 and then supplied to the gate electrode of the PMOS transistor 422. As a result, the PMOS clamp transistor 422 is turned off so that the clamp operation cannot be performed. The threshold voltage of the control circuit 6 is set to the value considering the fluctuation in the power source voltage generated by the normal operation of the internal circuit 3, whereby there can be avoided the situation where the clamp circuit 4 malfunctions by responding to the fluctuation in the power source voltage caused by the normal operation of the internal circuit 3.

### Sixth Embodiment

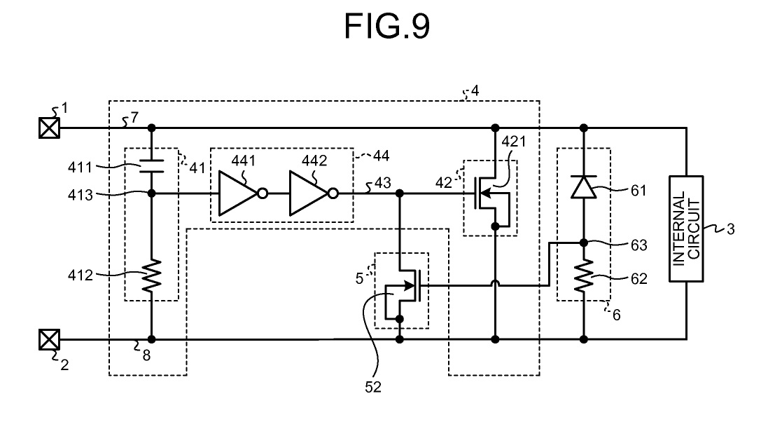

FIG. 9 is a diagram illustrating a sixth embodiment. The elements corresponding to the elements in the already described embodiments are given the same reference numbers, and the explanation of these elements may not be repeated. In this embodiment, the clamp circuit 4 includes a buffer circuit 44 between the third common node 413 of the trigger circuit 41 and the gate electrode of the NMOS clamp transistor 421. The buffer circuit 44 includes two-stage inverter circuits (441 and 442) connected in series. Each of the inverter circuits (441 and 442) is formed of a CMOS inverter circuit, for example.

According to this embodiment, the buffer circuit 44 is included to allow the trigger signal from the trigger circuit 41 to undergo waveform shaping and be amplified to be supplied to the gate electrode of the NMOS clamp transistor 421. The drive capability of the NMOS clamp transistor 421 can be enhanced as a result.

While certain embodiments have been described, these embodiments have been presented by way of example only, and are not intended to limit the scope of the inventions. Indeed, the embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A semiconductor circuit comprising:
an internal circuit connected between a first power source line and a second power source line;
a clamp circuit connected between the first power source line and the second power source line, the clamp circuit performing a clamp operation when turned on;
a control circuit configured to output a control signal in response to a voltage fluctuation between the first power source line and the second power source line; and
a switch unit configured to switch on-off the clamp circuit in response to the control signal.

2. The semiconductor circuit according to claim 1, wherein the clamp operation is performed by electrically connecting the first power source line and the second power source line.

3. The semiconductor circuit according to claim 1, wherein the control circuit outputs the control signal when a voltage between the first power source line and the second power source line exceeds a predetermined threshold voltage.

4. The semiconductor circuit according to claim 1, wherein
the clamp circuit includes:
a trigger circuit configured to output a trigger signal in response to a voltage between the first power source line and the second power source line; and
a clamp element, a main current path of which is connected between the first power source line and the second power source line and which is controlled on-off by the trigger signal, and
the switch unit turns on or off the clamp element in response to the control signal.

5. The semiconductor circuit according to claim 3, wherein the clamp element includes a first transistor, a control electrode of which is connected to the switch unit.

6. The semiconductor circuit according to claim 4, wherein the trigger circuit includes a first RC circuit including a capacitor and a resistor.

7. The semiconductor circuit according to claim 5, wherein the clamp circuit includes a buffer circuit configured to supply an output signal to the control electrode of the first transistor in response to a trigger signal.

8. The semiconductor circuit according to claim 5, wherein the switch unit includes a second transistor, a main current path of which is connected between the control electrode of the first transistor and the second power source line, and a control electrode of which receives the control signal.

9. The semiconductor circuit according to claim 1, wherein the control circuit includes a series circuit of a diode and a resistor, the diode is reverse-biased by a voltage applied between the first power source line and the second power source line when the internal circuit is in a steady-state condition, and the control circuit outputs the control signal by conduction of the diode when the voltage between the first power source line and the second power source line exceeds a predetermined threshold voltage.

10. The semiconductor circuit according to claim 3, wherein the control circuit includes a series circuit of a diode and a resistor, the diode is reverse-biased by a voltage applied between the first power source line and the second power source line when the internal circuit is in a steady-state condition, and the control circuit outputs the control signal by conduction of the diode when the voltage between the first power source line and the second power source line exceeds a predetermined threshold voltage.

11. The semiconductor circuit according to claim 4, wherein the control circuit includes a series circuit of a diode and a resistor, the diode is reverse-biased by a voltage applied between the first power source line and the second power source line when the internal circuit is in a steady-state condition, and the control circuit outputs the control signal by conduction of the diode when the voltage between the first power source line and the second power source line exceeds a predetermined threshold voltage.

12. The semiconductor circuit according to claim 8, wherein
each of the first transistor and the second transistor includes an NMOS transistor, and
a main current path of the second transistor is connected between the second power source line and a gate electrode of the first transistor.

13. The semiconductor circuit according to claim 8, wherein
each of the first transistor and the second transistor includes a PMOS transistor, and
a main current path of the second transistor is connected between the first power source line and a gate electrode of the first transistor.

14. The semiconductor circuit according to claim 9, wherein the control circuit outputs the control signal from a connection node between the diode and the resistor.

15. A semiconductor circuit comprising:
a first power source line to which a high potential voltage is applied;
a second power source line to which a low potential voltage is applied;
an internal circuit connected between the first power source line and the second power source line;
a CR circuit connected between the first power source line and the second power source line;
a first transistor having a main current path connected between the first power source line and the second power source line and having a control electrode that receives a signal from the CR circuit;
a control circuit configured to be connected between the first power source line and the second power source line and output a control signal when a voltage between the first power source line and the second power source line exceeds a predetermined threshold voltage; and
a second transistor having a main current path connected between the first power source line and the control electrode of the first transistor and having a control electrode that receives the control signal.

16. The semiconductor circuit according to claim 15, wherein the control circuit includes a series circuit of a diode and a resistor, the diode is reverse-biased by a voltage applied between the first power source line and the second power source line when the internal circuit is in a steady-state condition, and the control circuit outputs the control signal by conduction of the diode when the voltage between the first power source line and the second power source line exceeds the predetermined threshold voltage.

17. The semiconductor circuit according to claim 16, wherein
the first transistor is a PMOS transistor having a main current path connected between the first power source line and the second power source line, and
the second transistor is a PMOS transistor having a main current path connected between the control electrode of the first transistor and the first power source line.

18. A semiconductor circuit comprising:
a first power source line to which a high potential voltage is applied;
a second power source line to which a low potential voltage is applied;
an internal circuit connected between the first power source line and the second power source line;
a CR circuit connected between the first power source line and the second power source line;
a first transistor having a main current path connected between the first power source line and the second power source line and having a control electrode that receives a signal from the CR circuit;
a control circuit configured to be connected between the first power source line and the second power source line and output a control signal when a voltage between the first power source line and the second power source line exceeds a predetermined threshold voltage; and
a second transistor having a main current path connected between the control electrode of the first transistor and the second power source line, and having a control electrode that receives the control signal.

19. The semiconductor circuit according to claim 18, wherein the control circuit includes a series circuit of a diode and a resistor, the diode is reverse-biased by a voltage applied between the first power source line and the second power source line when the internal circuit is in a steady-state condition, and the control circuit outputs the control signal by conduction of the diode when the voltage between the first power source line and the second power source line exceeds the predetermined threshold voltage.

20. The semiconductor circuit according to claim 19, wherein
the first transistor is an NMOS transistor having a main current path connected between the first power source line and the second power source line, and
the second transistor is an NMOS transistor having a main current path connected between the control electrode of the first transistor and the second power source line.
